(19) United States
(12) Patent Application Publication
(10) Pub. No.: US 2026/0267771 A1
(43) Pub. Date: Sep. 10, 2026

(54) INTERFACE IN TEMPLATE-BASED DEPLOYMENTS INTELLIGENT COMPUTING PLATFORM INTEGRATION SYSTEM AND METHOD

(71) Applicant: Dell Products L.P., Round Rock, TX (US)

(72) Inventors: Parminder Singh Sethi, Ludhiana (IN); Mohan Pujari, Belagavi (IN); Vasantha Kumar Venkataramanappa, Bengaluru (IN); Priyanga Srinivasan, Salem (IN); Sravana Kumar Reddy Butti, Bangalore (IN); Ravi Sastry Saripalli, Bangalore (IN)

(73) Assignee: Dell Products L.P., Round Rock, TX (US)

(21) Appl. No.: 19/071,191

(22) Filed: Mar. 5, 2025

(51) Int. Cl. G06F 11/3604

(52) U.S. Cl. CPC G06F 11/3608

(57) ABSTRACT

Systems and methods for a software identity and integrity securing system and method to integrate multi-step manual procedures, and translate incremental platform configurations to generate a production firmware image according to one embodiment of the present disclosure are disclosed. According to one embodiment, an Information Handling System (IHS) may include program instructions stored in a memory coupled to a processor, the program instructions that, upon execution by the processor, cause the IHS to determine, using business logic, using rules or actions that determine how the computing platform is supposed to function, receive hardware information about each of multiple processors or other hardware components that may be used in the computing platform, and generate an initial firmware image using the business logic and the received hardware information.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Historically, IHSs with desktop and laptop form factors have had conventional Operating Systems (OSs), such as LINUX, WINDOWS, MAC, and the like. Other types of processors, such as ARM processors, have been used in smartphones and tablet devices, which typically run thinner or mobile OSs, such as ANDROID, IOS, WINDOWS MOBILE, and the like. More recently, however, IHS manufacturers have started producing desktop and laptop IHSs equipped with ARM-based platforms.

Devices known as Embedded Controllers (ECs) have played a central role in their overall operation of conventional desktop and laptop platforms. Essentially, an EC is a microcontroller or processing core mounted on an IHS's motherboard which is configured to manage several critical IHS processes, ranging from early power rail sequencing to power limits and thermal limits, and to provide low-level hardware controls via a myriad of General-Purpose Input/Outputs (GPIOs). The EC is also responsible for facilitating Out-of-Band (OOB) management of its IHS. OOB management involves the use of dedicated interfaces for accessing and managing aspects of an IHS from a remote location, through a plane separate from the production network.

### SUMMARY

Systems and methods for a software identity and integrity securing system and method to integrate multi-step manual procedures, and translate incremental platform configurations to generate a production firmware image according to one embodiment of the present disclosure are disclosed. According to one embodiment, an Information Handling System (IHS) may include program instructions stored in a memory coupled to a processor, the program instructions that, upon execution by the processor, cause the IHS to determine, using business logic, using rules or actions that determine how the computing platform is supposed to function, receive hardware information about each of multiple processors or other hardware components that may be used in the computing platform, and generate an initial firmware image using the business logic and the received hardware information.

According to another embodiment, an intelligent computing platform integration method includes the steps of determining, using business logic, using rules or actions that determine how a computing platform is supposed to function, receiving hardware information about each of multiple processors or other hardware components that may be used in the computing platform, and generating an initial firmware image using the business logic and the received hardware information.

According to yet another embodiment, a non-transitory memory storage device has program instructions stored thereon that, upon execution by an Information Handling System (IHS), cause the IHS to determine, using business logic, using rules or actions that determine how the computing platform is supposed to function, receive hardware information about each of multiple processors or other hardware components that may be used in the computing platform, and generate an initial firmware image using the business logic and the received hardware information.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 shows an example of an IHS that may be configured to implement a software identity and integrity securing system and method according to embodiments of the present disclosure.

FIG. 2 illustrates an example intelligent computing platform integration system that may be used to expedite an overall platform development process that may achieve early TTM or FTM according to one embodiment of the present disclosure.

FIG. 3 illustrates several of the components of the intelligent computing platform integration system showing how the Firmware Generation Tool may be used to generate production firmware according to one embodiment of the present disclosure.

FIG. 4 illustrates an example intelligent computing platform integration method that may be used to integrate multi-step manual procedures, and translate incremental platform configurations to generate a production firmware image according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components. An example of an IHS is described in more detail below.

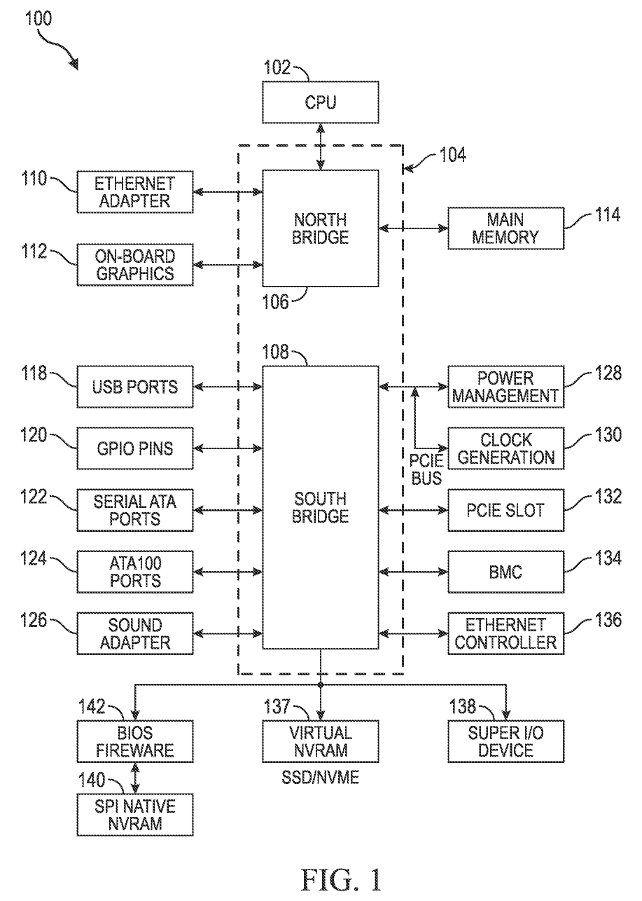

An IHS may include random access memory (RAM), one or more processing resources such as a central processing unit (CPU) or hardware or software control logic, ROM, and/or other types of nonvolatile memory. Additional components of an IHS may include one or more disk drives, one or more network ports for communicating with external devices as well as various input and output (I/O) devices, such as a keyboard, a mouse, touchscreen and/or a video display. An IHS may also include one or more buses operable to transmit communications between the various hardware components. A more detailed example of an IHS is described with respect to FIG. 1. It should be appreciated that although certain embodiments are discussed in the context of a personal computing device, other embodiments may utilize other types of IHSs.

In an enterprise server (IHS), the number of components, their complexities and capabilities are ever evolving. This directly translates to proportional increase in the time needed for critical milestones like new platform enablement, firmware stability, validation and Time-To-Market (TTM) or First-To-market (FTM) launch. Within this disclosure, platform development generally refers to the act of developing software with its associated hardware (e.g., processors, memory, expansion cards, etc.) such that a fully developed IHS may be provided that performs its intended purpose. Conventional platform enablement involves multi-step manual procedures, which often encompasses repurposing prior generation platform information, translating technical specifications in various formats to firmware consumable configurations, integrating incremental feature enhancements and so on.

According to embodiments of the present disclosure, an intelligent computing platform integration system and method is provided that integrates multi-step manual procedures, translates incremental platform configurations and help with platform bring-up activity on-the-go, expediting the overall platform enablement process that may achieve early TTM or FTM. In today’s highly competitive market of Enterprise servers, FTM provides an edge to OEMs to gain disproportional market share on new servers (e.g., Nvidia Artificial Intelligence (AI)), by delivering new and efficient servers early to the customer.

FIG. 1 shows an example of an IHS 100 that may be configured to implement an intelligent computing platform integration system and method according to one embodiment of the present disclosure. It should be appreciated that although certain embodiments described herein may be discussed in the context of a desktop or server computer, other embodiments may be utilized with virtually any type of IHS 100. Particularly, the IHS 100 includes a baseboard or motherboard, to which is a printed circuit board (PCB) to which components or devices are mounted by way of a bus or other electrical communication path. For example, Central Processing Unit (CPU) 102 operates in conjunction with a chipset 104. CPU 102 is a processor that performs arithmetic and logic necessary for the operation of the IHS 100.

Chipset 104 includes northbridge 106 and southbridge 108. Northbridge 106 provides an interface between CPU 102 and the remainder of the IHS 100. Northbridge 106 also provides an interface to a random access memory (RAM) used as main memory 114 in the IHS 100 and, possibly, to on-board graphics adapter 112. Northbridge 106 may also be configured to provide networking operations through Ethernet adapter 110. Ethernet adapter 110 is capable of connecting the IHS 100 to another IHS 100 (e.g., a remotely located IHS 100) via a network. Connections which may be made by Ethernet adapter 110 may include local area network (LAN) or wide area network (WAN) connections. Northbridge 106 is also coupled to southbridge 108.

Southbridge 108 is responsible for controlling many of the input/output (I/O) operations of the IHS 100. In particular, southbridge 108 may provide one or more universal serial bus (USB) ports 118, sound adapter 126, Ethernet controller 136, and one or more general purpose input/output (GPIO) pins 120. Southbridge 108 may also provide a bus for interfacing peripheral card devices such as PCIe slot 132. In some embodiments, the bus may include a peripheral component interconnect (PCI) bus. Southbridge 108 may also provide baseboard management controller (BMC) 134 for use in managing the various components of the IHS 100. Power management circuitry 128 and clock generation circuitry 130 may also be utilized during operation of southbridge 108.

Additionally, southbridge 108 is configured to provide one or more interfaces for connecting mass storage devices to the IHS 100. For instance, in one embodiment, southbridge 108 may include a serial advanced technology attachment (SATA) adapter for providing one or more serial ATA ports 122 and/or an ATA100 adapter for providing one or more ATA100 ports 122. Serial ATA ports 122 and ATA100 ports 124 may be, in turn, connected to one or more mass storage devices storing an operating system (OS) and application programs.

An OS may comprise a set of programs that controls operations of the IHS 100 and allocation of resources. An application program is software that runs on top of the OS and uses computer resources made available through the OS to perform application-specific tasks desired by the user.

Mass storage devices connected to southbridge 108 and PCIe slot 132, and their associated computer-readable media provide non-volatile storage for the IHS 100. Although the description of computer-readable media contained herein refers to a mass storage device, such as a hard disk or CD-ROM drive, it should be appreciated by a person of ordinary skill in the art that computer-readable media can be any available media on any memory storage device that can be accessed by the IHS 100. Examples of memory storage devices include, but are not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices.

A low pin count (LPC) interface may also be provided by southbridge 108 for connecting Super I/O device 138. Super I/O device 138 is responsible for providing a number of I/O ports, including a keyboard port, a mouse port, a serial interface, a parallel port, and other types of input/output ports.

The LPC interface may connect a computer storage media such as a ROM or a flash memory such as a non-volatile random access memory (NVRAM) for storing BIOS/firmware 142 that includes BIOS program code containing the basic routines that help to start up the IHS 100 and to transfer information between elements within the IHS 100. BIOS/firmware 142 comprises firmware compatible with the Extensible Firmware Interface (EFI) Specification and Framework.

The LPC interface may also be utilized to connect virtual NVRAM 137 (e.g., SSD/NVMe) to the IHS 100. The virtual NVRAM 137 may be utilized by BIOS/firmware 142 to store configuration data for the IHS 100. In other embodiments, configuration data for the IHS 100 may be stored on the same virtual NVRAM 137 as BIOS/firmware 142. The IHS 100 may also include a SPI native NVRAM 140 coupled to the BIOS 142.

BMC 134 may include non-volatile memory having program instructions stored thereon that enable remote management of the IHS 100. For example, BMC 134 may enable a user to discover, configure, and manage the IHS 100, setup configuration options, resolve and administer hardware or software problems, etc. Additionally or alternatively, BMC 134 may include one or more firmware volumes, each volume having one or more firmware files used by the BIOS’ firmware interface to initialize and test components of the IHS 100.

As a non-limiting example of BMC 134, the integrated DELL Remote Access Controller (iDRAC) from DELL, INC. is embedded within DELL POWEREDGE servers and provides functionality that helps information technology (IT) administrators deploy, update, monitor, and maintain servers with no need for any additional software to be installed. The iDRAC works regardless of OS or hypervisor presence from a pre-OS or bare-metal state because iDRAC is embedded within the IHS 100 from the factory.

It should be appreciated that, in other embodiments, the IHS 100 may comprise other types of computing devices, including hand-held computers, embedded computer systems, personal digital assistants, and other types of computing devices. It is also contemplated that the IHS 100 may not include all of the components shown in FIG. 1, may include other components that are not explicitly shown in FIG. 1, or may utilize a different architecture.

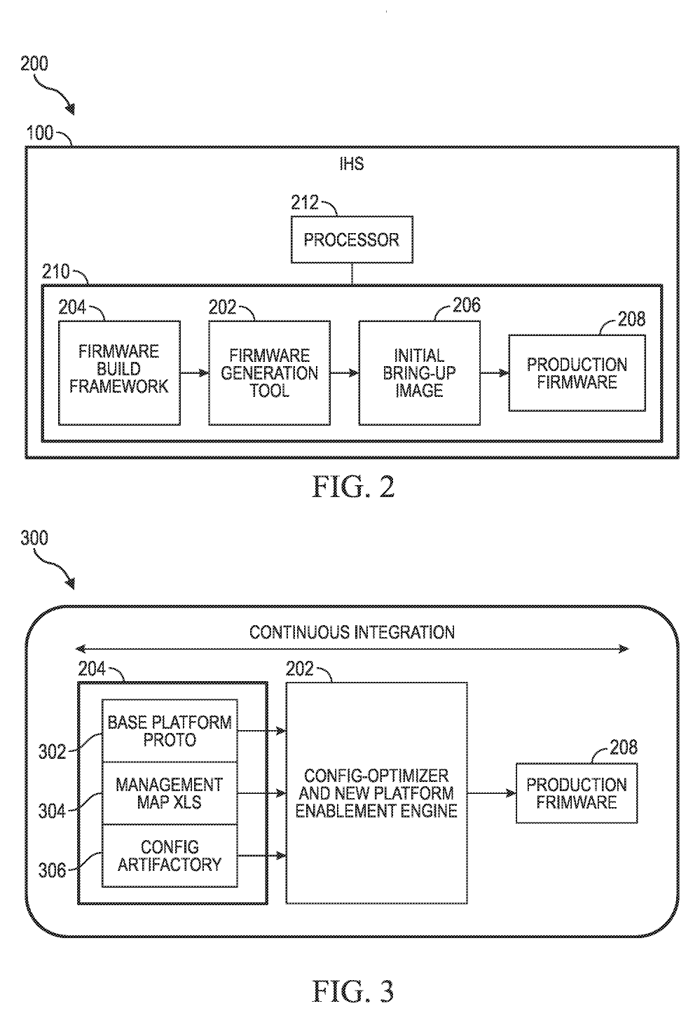

FIG. 2 illustrates an example intelligent computing platform integration system 200 that may be used to expedite an overall platform development process that may achieve early TTM or FTM according to one embodiment of the present disclosure. The intelligent computing platform integration system 200 includes a Firmware Generation Tool 202 and a firmware build framework 204 stored in a memory 210. The Firmware Generation Tool 202 is executed by a processor 212 and uses the firmware build framework 202 to generate an initial firmware image 206. The initial firmware image 206 may in turn, be modified to generate a production firmware image 208 that is shipped with a computing platform, such as a server, work station, laptop computer, a computing device (e.g., NIC card, memory module, GPIO device, etc.), and the like. In one embodiment, the computing platform may include a BMC 134, such as described above with reference to FIG. 1. In general, the Firmware Generation Tool 202 receives information from the Firmware Build Framework 204 to generate the initial firmware image 206 as will be described in detail herein below.

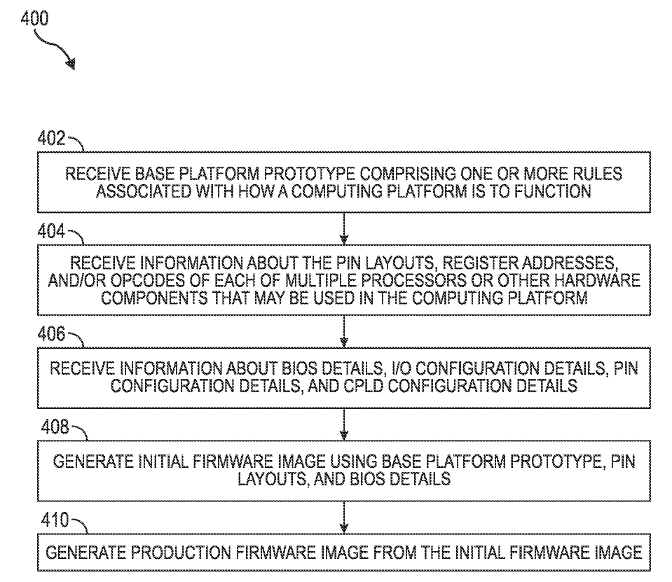

FIG. 3 illustrates several of the components of the intelligent computing platform integration system 200 showing how the Firmware Generation Tool 202 may be used to generate production firmware 208 according to one embodiment of the present disclosure. The Firmware Build Framework 204 includes a base platform prototype 302, a management map 304, and a configuration artifactory 306. The Base Platform Prototype 302 includes business logic, such as executable instructions including real-world rules or actions that determine how the computing platform is supposed to function, and may be at least somewhat agnostic to the underlying hardware used to implement those rules. On the other hand, the Management Map 304 and Configuration Artifactory 306 may include specific information about the hardware on which the business logic is executed. In one embodiment, the Management Map 304 may include information included in a spreadsheet form (e.g., XLS) form.

For example, the Management Map 304 may include specific information about the pin layouts, register addresses, and/or opcodes of each of multiple processors or other hardware components that may be used in the computing platform. For another example, the configuration artifactory 306 may include information about the underlying computing platform for which the production firmware 208 is being generated, such as BIOS details, I/O (e.g., I2C) configuration details, pin configuration details (e.g., GPIO configuration details), and/or CPLD configuration details.

Such a platform may provide an efficient solution to adopting different hardware components on a computing platform while maintaining the business logic used to implement the functionality on it. For example, if the developers of a particular computing platform, such as a BMC 134, may desire to use a different processor due to its enhanced performance over a currently used processor, they can generate another management map 304 that reflects the hardware nuances (e.g., differences) of that processor so that an initial build image 206 may be generated while maintaining the currently defined business logic that has already been generated. Additionally, the configuration artifactory 306 may be useful for generating maintaining business logic for differences in the computing platform, such as BIOS nuances or differences in certain hardware implementations (e.g., BIOS implementations, EC implementations, etc.) in different servers (e.g., IHSs).

Whereas conventional computing platform development has involved fragmented ownership of each of multiple components that are responsible for providing technical requirements in various input configuration file formats, the intelligent computing platform integration system 200 stores computing platform information (e.g., GPIO details, I2C details, BIOS details, etc.), and configuration artifactory information, such as hardware information (e.g., processor pin layout, register location, opcode differences, etc.) about the different hardware components that may be used in the computing platform. In an ever continuing development process, these requirement files may evolve along with the platform process, which often requires platform personnel to do continuous integration manually to accommodate the evolving specifications. Such a conventional process consumes lot of time and may be error prone. Embodiments of the present disclosure provides a Firmware Build Framework 204 firmware build framework that integrates the firmware at build time that performs fetching some, most, or all the aforementioned configuration documents and specifications, intelligently converts all the requirements into a specific format used at firmware run time, and provides production grade Firmware in at least real time. In some cases, the intelligent computing platform integration system 200 may reduce or void manual intervention, which otherwise is susceptible to human errors.

FIG. 4 illustrates an example intelligent computing platform integration system and method 400 that may be used to integrate multi-step manual procedures, and translate incremental platform configurations to generate a production firmware image according to one embodiment of the present disclosure. Additionally or alternatively, the intelligent computing platform integration method 400 may be performed by the intelligent computing platform integration system 200 as described above with reference to FIGS. 2 and 3. In one embodiment, the intelligent computing platform integration method 400 may be performed each time a computing platform, such as a BMC 134, is updated, for example, with a different processor or other hardware component.

Initially at step 402, the intelligent computing platform integration method 400 receives a base platform prototype comprising one or more rules associated with how a computing platform is to function. In one embodiment, the base platform prototype may include business logic, such as executable instructions including real-world rules or actions that determine how the computing platform is supposed to function, and may be at least somewhat agnostic to the underlying hardware and/or computing platform used to implement those rules. At step 404, the intelligent computing platform integration method 400 may receive hardware information about each of multiple processors or other hardware components that may be used in the computing platform. The hardware information may include, for example, the pin layouts, register addresses, and/or opcodes of each of multiple processors or other hardware components that may be used in the computing platform.

At step 406, the intelligent computing platform integration method 400 receives computing environment information, such as BIOS details, I/O (e.g., I2C) configuration details, pin configuration details (e.g., GPIO configuration details), and/or CPLD configuration details. For example, in a particular instance in which the computing platform is a BMC 134, the computing environment information may include information about other processors on the BMC 134, such as a CPLD along with its logic functions. In one embodiment, the computing environment information may include information about any expansion cards that may be configured in the computing platform. For example, a particular computing platform model may be configured with a different NIC card than another computing platform model. As such, the computing environment information may include information that allows the initial firmware image to function properly with that NIC card.

At step 408, the intelligent computing platform integration method 400 generates an initial firmware image using base platform prototype, hardware information, and computing environment information. The intelligent computing platform integration method 400 may then generate production firmware from the initial firmware image at step 410. For example, the production firmware image may involve testing the initial firmware image on the computing platform, and using the test results, make any final modifications to the initial firmware image in order to generate the production firmware image.

The aforedescribed steps may be repeatedly performed each time that the computing platform is updated with new or different components. Nevertheless, when use of the intelligent computing platform integration method 400 is no longer needed or desired, the process ends.

Although FIG. 4 describes how the intelligent computing platform integration system 200 may be used to provide an intelligent computing platform integration method, the features of the process may be embodied in other specific forms without deviating from the spirit and scope of the present disclosure. For example, the process may perform additional, fewer, or different operations than those described in the present examples. For another example, the process may be performed in a sequence of steps different from that described above. For yet another example, the process may be performed by components other than what is described herein above.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterward be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS), comprising:
a processor;
a computing platform;
program instructions stored in a memory coupled to a processor, the program instructions that, upon execution by the processor, cause the IHS to:
determine, using business logic, using rules or actions that determine how the computing platform is supposed to function;
receive hardware information about each of multiple processors or other hardware components that may be used in the computing platform; and
generate an initial firmware image using the business logic and the received hardware information.

2. The IHS of claim 1, wherein the business logic is agnostic to the underlying hardware used to implement the rules or actions.

3. The IHS of claim 1, wherein the hardware information comprises specific information about at least one of a pin layout, one or more register addresses, or one or more opcodes of each of one or more hardware components that are used in the computing platform.

4. The IHS of claim 1, wherein the program instructions, upon execution by the host processor, further cause the IHS to generate the initial firmware image using computing platform information.

5. The IHS of claim 4, wherein the computing platform information comprises specific information about the pin layouts, register addresses, and/or opcodes of each of multiple processors or other hardware components that may be used in the computing platform.

6. The IHS of claim 1, wherein the computing platform information comprises a spreadsheet.

7. The IHS of claim 1, wherein the computing platform comprises a Baseboard Management Controller (BMC).

8. The IHS of claim 1, wherein the program instructions, upon execution by the host processor, further cause the IHS to generate a production firmware image using the initial firmware image using test information generated by testing the initial firmware image on the computing platform.

9. An intelligent computing platform integration method comprising:
determining, using business logic, using rules or actions that determine how a computing platform is supposed to function;
receiving hardware information about each of multiple processors or other hardware components that may be used in the computing platform; and
generating an initial firmware image using the business logic and the received hardware information.

10. The intelligent computing platform integration method of claim 9, wherein the business logic is agnostic to the underlying hardware used to implement the rules or actions.

11. The intelligent computing platform integration method of claim 10, wherein the computing platform information comprises specific information about at least one of the pin layouts, register addresses, and/or opcodes of each of multiple processors or other hardware components that may be used in the computing platform.

12. The intelligent computing platform integration method of claim 9, wherein the computing platform comprises a Baseboard Management Controller (BMC).

13. The intelligent computing platform integration method of claim 9, further comprising generating a production firmware image using the initial firmware image using test information generated by testing the initial firmware image on the computing platform.

14. A non-transitory memory storage device having program instructions stored thereon that, upon execution by an Information Handling System (IHS), cause the IHS to:
determine, using business logic, using rules or actions that determine how the computing platform is supposed to function;
receive hardware information about each of multiple processors or other hardware components that may be used in the computing platform; and
generate an initial firmware image using the business logic and the received hardware information.

15. The non-transitory memory storage device of claim 14, wherein the business logic is agnostic to the underlying hardware used to implement the rules or actions.

16. The non-transitory memory storage device of claim 14, wherein the hardware information comprises specific information about at least one of a pin layout, one or more register addresses, or one or more opcodes of each of one or more hardware components that are used in the computing platform.

17. The non-transitory memory storage device of claim 14, wherein the program instructions, upon execution by the host processor, further cause the IHS to generate the initial firmware image using computing platform information.

18. The non-transitory memory storage device of claim 17, wherein the computing platform information comprises specific information about the pin layouts, register addresses, and/or opcodes of each of multiple processors or other hardware components that may be used in the computing platform.

19. The non-transitory memory storage device of claim 14, wherein the computing platform comprises a Baseboard Management Controller (BMC).

20. The non-transitory memory storage device of claim 14, wherein the program instructions, upon execution by the host processor, further cause the IHS to generate a production firmware image using the initial firmware image using test information generated by testing the initial firmware image on the computing platform.
